(19) United States
(12) Patent Application Publication
(10) Pub. No.: US 2024/0198789 A1
(43) Pub. Date: Jun. 20, 2024

(54) AXLE SHAFT WITH REVERSIBLE FLANGE

(71) Applicant: Dana Heavy Vehicle Systems Group, LLC, Maumee, OH (US)

(72) Inventors: Jared REICHERT, Pemberville, OH (US); Gustav JOHNSON, Canton, MI (US); Jordan M. HOUSER, Sylvania, OH (US)

(21) Appl. No.: 18/066,672

(22) Filed: Dec. 15, 2022

(51) Int. Cl. B60K 17/02; B60B 27/06; B60B 35/12; B60B 35/18; B60L 15/20

(52) U.S. Cl. CPC B60K 17/02; B60B 27/06; B60B 35/122; B60B 35/18; B60L 15/20; B60B 2380/14

(57) ABSTRACT

Systems and methods for an axle shaft system of an electric vehicle are provided. A reversible axle shaft flange is optionally couplable to the axle shaft such that in a first orientation, the reversible axle shaft flange is coupled to the axle shaft and in a second reverse orientation, the reversible axle shaft flange is decoupled from the axle shaft. The reversible axle shaft flange is detachable in order to reverse an orientation and reinstall in the other orientation. The reversible axle shaft flange couples to a wheel hub via a plurality of fasteners such that torque is transferred from the axle shaft to a wheel via the reversible axle shaft flange in the first orientation. With the axle shaft in a decoupled state, rotation is not transferred from the wheel to an electric machine such that a towing operation with wheels in contact with ground is possible.

### TECHNICAL FIELD

Embodiments of the subject matter disclosed herein relate to axle shaft designs, specifically an axle shaft design for towing an electric vehicle.

### BACKGROUND AND SUMMARY

Towing with modern electrically drivable motor vehicles may be more cumbersome than with motor vehicles that comprise an internal combustion engine. As opposed to a vehicle with an internal combustion engine where a motor is disconnected from wheels in a neutral operating gear, wheels of an electric vehicle are not readily disconnectable from an electric motor. Towing of a vehicle with an internal combustion engine includes using the neutral operating gear to disconnect the wheels from the motor so that when the wheels spin from being in contact with the ground, the motor is not inordinately affected. If the wheels of the electric vehicle spin, such as would occur with use of a tow dolly where two wheels are in contact with the ground and spinning, or flat towing where four wheels are in contact with the ground and spinning, the spin of the wheels in turn may spin the electric motor(s). Spinning of the electric motor(s) may create an electromagnetic field (EMF) even when no other power to the electric motor is applied. Such an EMF may cause overheating, short circuits, etc. to components of the electric vehicle.

In order to prevent the electric motor(s) from spinning, towing methods for electric vehicles currently include putting the electric vehicle in a flatbed trailer so the wheels may not rotate or disconnecting/removing an axle shaft in order to disconnect a driveline from the wheel. Issues arise with the aforementioned solutions to difficulties with towing an electric vehicle. For example, some commercial electric vehicles may not be able to be towed via a flatbed trailer due to height or load restrictions. For an axle disconnect, a differential will still spin as disconnects generally disconnect one wheel, leaving at least one other wheel available to spin the differential and therefore spin the electric motor(s). Additionally, disconnects often require power from the electric vehicle in order to function, and thus if a battery, compressor, or other is non-functioning, the axle disconnect may not be able to disconnect the axle shaft from the wheel.

The inventors herein have recognized the above-mentioned issues and have developed an axle shaft system that at least partially addresses these issues. In one example, the aforementioned issues may be addressed by a full-floating axle system including a removable, reversible axle shaft flange that in one orientation may couple to an axle shaft during normal operation of an electric vehicle and in a second orientation may decouple the axle shaft from a wheel of the vehicle for a towing operation.

By decoupling the axle shaft from the wheel, the electric vehicle may be towed in a manner, such as flat towing or dolly towing, where the wheels spin without transferring rotation to spin the electric motor(s) by way of disconnecting the wheels from the driveline. Thus, the electric vehicle may be towed in a manner that reduces possible load/height constraints, when no other power source is available, and in a more cost effective manner that does not have the potential to cause overheating, short circuits, or other types of issues to the components of the electric vehicle.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic of a vehicle with multiple components therein including front and rear axles and front and rear wheels. A control system is also shown.

FIG. 2A shows an axle shaft and a flange in a first orientation.

FIG. 2B shows the axle shaft and the flange in a second reversed orientation.

FIG. 3 shows a flowchart illustrating an example method for vehicle operation.

FIG. 4 shows a flowchart illustrating an example method for operating mode of an electric vehicle.

### DETAILED DESCRIPTION

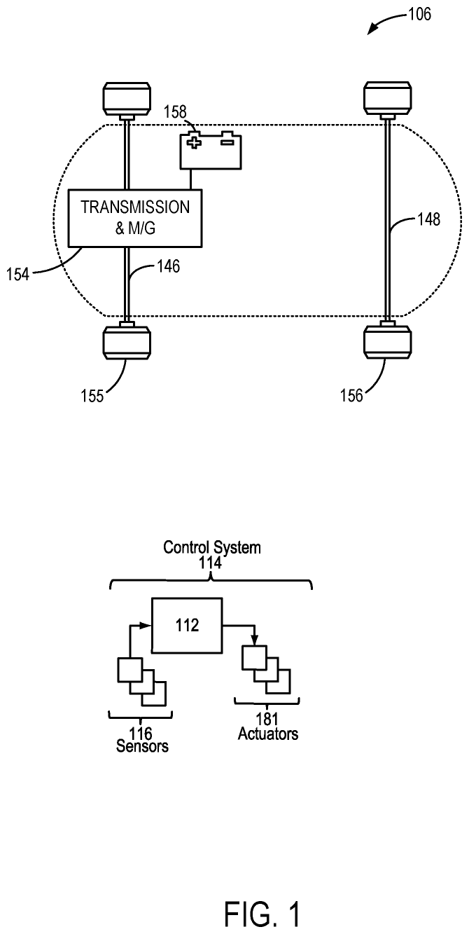

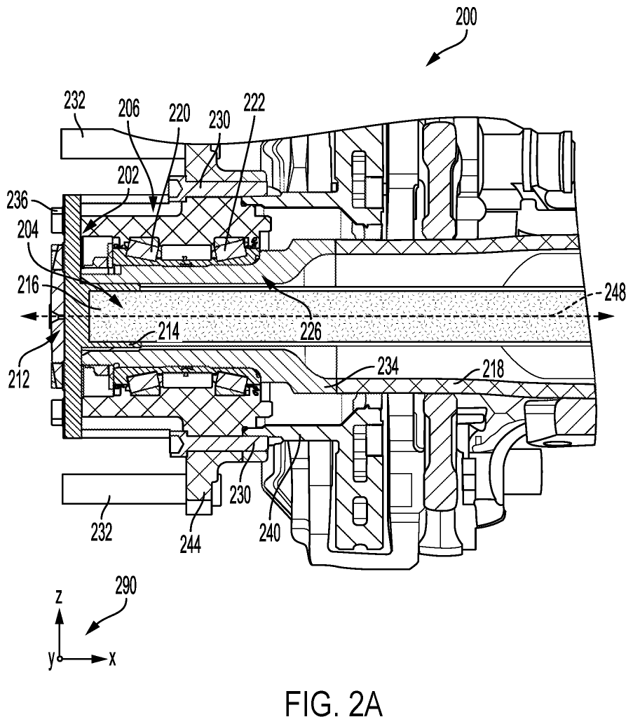

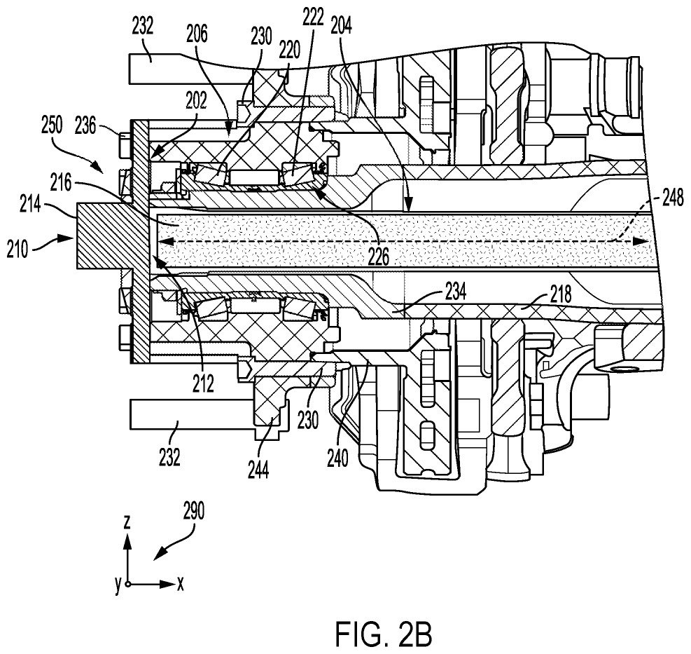

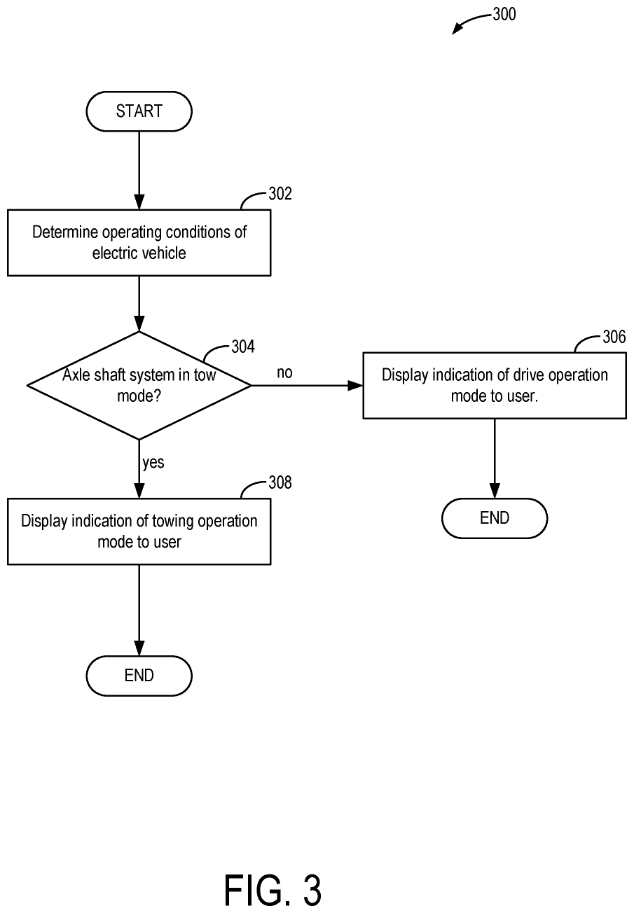

The following description relates to systems and methods for an axle shaft including a removable, reversible axle shaft flange that is optionally couplable to the axle shaft. One orientation of the flange may coupled to the axle shaft while another orientation (a reverse orientation) may be decoupled from the axle shaft so as to decouple the axle shaft from a wheel. A suitable electric vehicle in which the axle shaft and flange may be included is depicted in FIG. 1. A first orientation of the flange with relation to the axle shaft and a wheel hub is depicted in FIG. 2A. A second reversed orientation of the flange with relation to the axle shaft and the wheel hub is depicted in FIG. 2B. A method for determining and displaying operation mode of the electric vehicle is depicted in FIG. 3.

FIGS. 1-2B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

FIG. 1 shows a schematic depiction of a vehicle system 106 that can derive propulsion power from an electric motor 154 (e.g., an electric machine). In some examples, the vehicle system 106 may be an electric vehicle. In one embodiment, electric motor 154 may be a traction motor. Electric motor 154 receives electrical power from a traction battery 158 to provide torque to rear vehicle wheels 155. Electric motor 154 may also be operated as a generator to provide electrical power to charge traction battery 158, for example, during a braking operation. It should be appreciated that while FIG. 1 depicts an electric motor 154 mounted in a rear wheel drive configuration, other configurations are possible, such as employing electric motor 154 in a front wheel configuration, or in a configuration in which there is an electric motor mounted to both the rear vehicle wheels 155 and front vehicle wheels 156. Additionally, it should be appreciated that while FIG. 1 depicts one electric machine, the vehicle system 106 may include one or more electric machines providing torque to an output.

Electric motor 154 may include a gearbox integrated therein. Additionally or alternatively, the electric motor 154 may be coupled to an outside of a transmission/gearbox housing. The integrated gearbox may include one or more gears, shafts, and clutches to transmit power from the electric motor 154 to the output such as an axle shaft that couples to front vehicle wheels 156 or rear vehicle wheels 155. Controller 112 may send a signal to an actuator of the clutch(es) to engage or disengage the clutch(es), so as to couple or decouple power transmission from the electric motor 154 to the rear vehicle wheels 155 or the front vehicle wheels 156. Additionally or alternatively, there may be multiple traction batteries configured to provide power to different driven wheels, wherein power to the wheels may be predicated based on traction at the wheels, driver demand, and other conditions.

The transmission/gearbox may be further coupled to axle shafts configured to transfer rotational force from the transmission to the front vehicle wheels 156 and/or rear vehicle wheels 155. Axle shafts, such as rear axle shaft 146 and front axle shaft 148, may transfer rotational force from the transmission to wheels via a flange. The disclosure discussed herein provides an axle shaft that is optionally couplable/decouplable from a corresponding wheel based on an orientation of the flange. The flange (not shown in FIG. 1) may be removed from the axle shaft and wheel hub and reversed in orientation in order to switch the axle shaft from a coupled state to a decoupled state, or vice versa.

In some examples, the electric motor 154 may spin due to wheels, such as front vehicle wheels 156 or rear vehicle wheels 155, spinning even if there is no other source of power to the electric motor 154. Such may be during a towing operation wherein a towing device (not shown) couples the vehicle system 106 to a towing vehicle (not shown). During the towing operation, the wheels, either the rear wheels alone with use of a tow dolly or both the front and rear wheels during a flat tow, are in contact with a ground and spinning as the vehicle system 106 is being towed by the towing vehicle. Spinning of the electric motor 154 may generate counter electromotive force and/or an electromagnetic field and as a result overheating or short circuits may occur within the vehicle system 106. Disconnecting the axle shaft from the wheels by way of reversing the orientation of the flange interrupts the transfer of rotational torque when the wheels spin and as a result, the vehicle system 106 may be towed with wheels in contact with the ground without causing degradation to the electric motor 154 or other components of the vehicle system 106.

The vehicle system 106 may comprise a user input device such as a touch screen display or other display that may indicate to a user whether the vehicle system 106 is in a drive operation mode or a towing operation mode. The drive operation mode may be normal operation of the vehicle system 106. The vehicle system 106 may contain sensors to detect an orientation of the flange in order to determine whether the vehicle system 106 is in a drive operation mode (e.g., the flange is in a first orientation coupled to the axle shaft) or a towing operation mode (e.g., the flange is in a second reverse orientation decoupled from the axle shaft). Alternatively, a user may input information via the user input device to indicate to the vehicle system 106 which operation mode the vehicle system 106 is in based on user knowledge of the orientation of the flange.

Controller 112 may form a portion of a control system 114. Control system 114 is shown receiving information from a plurality of sensors 116 and sending control signals to a plurality of actuators 181. As one example, sensors 116 may include sensors such as a battery level sensor, clutch activation sensor, etc. As another example, the actuators may include the clutch, etc. The controller 112 may receive input data from the various sensors, process the input data, and trigger the actuators in response to the processed input data based on instruction or code programmed therein corresponding to one or more routines.

Referring now to FIG. 2A, an exemplary axle shaft system 200 of an electric vehicle, such as vehicle system 106 of FIG. 1, with a reversible axle shaft flange 202 in a first orientation is shown. An axis 290 is provided in FIG. 2A for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations in other examples.

Axle shaft system 200 comprises an axle shaft 204, the reversible axle shaft flange 202, a bearing assembly 226, and a wheel hub 206. The axle shaft system 200 herein described may be a full-floating axle system, though other types of axle systems such as semi-floating axle systems have been contemplated. In some examples, the axle shaft 204 is positioned parallel to the horizontal axis of axis 290 and may rotate about a rotational axis 248. In the depiction of FIGS. 2A and 2B, an outboard aspect of the axle shaft 204 is shown on a left side of the figure and an inboard aspect of the axle shaft 204 is shown on an opposing right side of the figure. Although FIGS. 2A and 2B depict only one axle shaft system, it should be understood that in some examples, the electric vehicle (e.g., vehicle system 106 of FIG. 1) may comprise more than one axle shaft system. In some examples, the number of axle shaft systems may correlate to the number of wheels included in the electric vehicle.

The axle shaft 204 may be housed within an axle tube 218. The axle tube 218 may be connected to a suspension system (not shown) of the electric vehicle. At the inboard end of the axle shaft 204, the axle shaft 204 may couple to a differential (not shown) which transfers rotational torque from a transmission of the electric vehicle to the axle shaft 204. The axle shaft 204 may extend through the axle tube 218 from the differential toward the bearing assembly 226. The axle shaft 204 may transfer torque from the differential to a wheel (not shown) to propel the electric vehicle (e.g., vehicle system 106 depicted in FIG. 1).

The bearing assembly 226 may include one or more bores and counterbores that serve as seats 224 for one or more bearings (e.g., bearing 220 and bearing 222). Such seats 224 of the bearing assembly 226 may be substantially anti-friction or may be lubricated such that the bearings 220, 222 may rotate during rotation of the wheel about the rotational axis 248. The bearing assembly 226 may couple to an exterior aspect of a spindle 234. The spindle 234 may surround the outboard aspect of the axle shaft 204 and axle tube 218. The spindle 234 may be coaxial with the axle shaft 204. The spindle 234 may couple to an inboard aspect (e.g., a first side) of the reversible axle shaft flange 202 when the reversible axle shaft flange 202 is in the first orientation. The bearing assembly 226 may further couple to an interior aspect of the wheel hub 206 such that the bearing assembly 226 is positioned between the wheel hub 206 and the spindle 234.

The spindle 234 may taper from its outboard aspect to its inboard aspect such that the diameter of the spindle 234 at the outboard aspect is smaller than the diameter of the spindle 234 at the inboard aspect. The wheel hub 206 may comprise a wheel hub projection 244. The wheel hub projection 244 may couple to a brake drum 240 via bolts 230. The wheel hub projection 244 may further have lug bolts 232 affixed thereto, the lug bolts 232 may project axially away from an outboard face of the wheel hub projection 244.

The bearings 220, 222 may fit into the seats of the bearing assembly 226. Bearings 220, 222 may be tapered roller bearings where the inboard bearing (e.g., bearing 222) lies at an angle where the outboard aspect of the bearing 222 is closer to the spindle 234 than the inboard aspect of the bearing 222 and where the outboard bearing (e.g., bearing 220) lies at an angle where the outboard aspect of the bearing 220 is further from the spindle 234 than the inboard aspect of the bearing 220. The inboard aspect of the bearing 220 may be at an equal distance from the spindle 234 compared to the outboard aspect of the bearing 222. The outboard aspect of the bearing 220 may be at an equal distance from the spindle 234 compared to the inboard aspect of bearing 222.

The reversible axle shaft flange 202 may fasten to the wheel hub 206 via a plurality of fasteners such as bolts or lug bolts. When the reversible axle shaft flange 202 is in the first orientation, such fasteners, for example bolt 236, may be seated on an outboard facing aspect (e.g., a second side 212) of the reversible axle shaft flange 202, passing through the reversible axle shaft flange 202 and affixing to the wheel hub 206 which is positioned at the inboard facing aspect (e.g., the first side 210) of the reversible axle shaft flange 202.

The reversible axle shaft flange 202 may further couple to the axle shaft 204 via a splined portion 214 of the reversible axle shaft flange 202. The splined portion 214 of the reversible axle shaft flange 202 may protrude axially parallel to the horizontal axis of axis 290. The axle shaft 204 and the reversible axle shaft flange 202 may be coaxially arranged, and thus the splined portion 214 of the reversible axle shaft flange 202 may be coaxial with the axle shaft 204. When the reversible axle shaft flange 202 is in the first orientation and the first side 210 of the reversible axle shaft flange 202 is facing towards the interior of the electric vehicle (e.g., inboard facing), the splined portion 214 of the reversible axle shaft flange 202 may couple to a corresponding splined portion 216 of the axle shaft 204. The splined portion 216 of the axle shaft 204 may be a portion towards an outboard end of the axle shaft 204. The splined portion 216 of the axle shaft 204 may be inserted into the splined portion 214 of the first side 210 such that when the axle shaft 204 rotates, the reversible axle shaft flange 202 rotates in unison with the axle shaft 204 about the rotational axis 248.

The splined portion 214 of the reversible axle shaft flange 202 may couple to an interior aspect of the spindle 234 such that no part of the axle shaft 204 contacts the spindle 234. Consequently, when the splined portion 214 of the reversible axle shaft flange 202 is not coupled to the splined portion 216 of the axle shaft 204, rotation may not be transferred from the axle shaft 204 to the wheel hub 206 given that the wheel hub 206 is directly coupled to the reversible axle shaft flange 202 and the bearing assembly 226, but is not directly coupled to the axle shaft 204.

When the reversible axle shaft flange 202 rotates, the wheel hub 206 to which the reversible axle shaft flange 202 is fastened also rotates. The wheel hub 206 may be a portion of a wheel assembly and may couple the reversible axle shaft flange 202 to the wheel (not shown) of the electric vehicle. When the reversible axle shaft flange 202 is in the first orientation as depicted in FIG. 2A, rotational power is transferred from an electric motor, through a transmission, to the axle shaft 204 and to the wheel of the electric vehicle.

Consequently, during conditions in which the reversible axle shaft flange 202 is in the first orientation and one or more electric machines of the electric vehicle is not providing power to the components, when the wheel spins, so does the electric motor. The wheels spinning causes the wheel hub 206 to spin, which in turn rotates the reversible axle shaft flange 202, which rotates the axle shaft 204 via the splined portion 214 of the reversible axle shaft flange 202 coupled to the splined portion 216 of the axle shaft 204. The axle shaft 204 rotating causes rotation of the driveline, which causes the electric motor to spin. The spin of the electric motor when it is not powered on by another source (e.g., a battery), may unduly cause overheating and/or short circuits of the vehicle system.

Towing with any number of wheels on the ground when the reversible axle shaft flange 202 is coupled to the axle shaft 204 may therefore cause degradation to components of the electric vehicle. The reversible axle shaft flange 202 herein described is removable by an operator (e.g., a user) so that it may be decoupled from the axle shaft 204 and the wheel hub 206. The reversible axle shaft flange 202 may then be reinstalled by the user in the second reverse orientation that provides a decoupled state for the axle shaft 204. The ability for the reversible axle shaft flange 202 to be reinstalled rather than simply removed allows for the wheel to be recoupled to the electric vehicle, reducing any cumbersome components that the operator need haul separate from the vehicle.

In a full-floating axle system such as is depicted in FIGS. 2A and 2B, the axle shaft 204 may serve to transfer rotational torque from the differential to the wheel, but does not carry a weight of the electric vehicle as some other types of axle systems do, such as semi-floating axle systems. With a full-floating axle system, the wheel hub 206 is mounted to the spindle 234 with the bearing assembly 226 between and this combination of components carries the weight of the electric vehicle. Consequently, decoupling the axle shaft 204 from the reversible axle shaft flange 202 may not affect load/weight carrying within the axle shaft system 200.

Referring now to FIG. 2B, exemplary axle shaft system 200 is depicted with the reversible axle shaft flange 202 in the second reverse orientation. In the second reverse orientation, the second side 212 of the reversible axle shaft flange 202 faces inboard toward the splined portion 216 of the axle shaft 204. The second side 212 of the reversible axle shaft flange 202 may be substantially flat insofar that in the second orientation of the reversible axle shaft flange 202, the second side 212 does not contact the axle shaft 204.

In the second reverse orientation, the plurality of fasteners, for example the bolt 236, may be seated at the first side 210 of the reversible axle shaft flange, affixing to the wheel hub 206 which is positioned at the opposing second side 212 of the reversible axle shaft flange 202. Bores through which the plurality of fasteners, for example bolt 236, are threaded to couple the reversible axle shaft flange 202 to the wheel hub 206 may be configured in such a way that the plurality of fasteners may thread through the bores from either the first side 210 or the second side 212. Thus, the reversible axle shaft flange 202 may be coupled to the wheel hub 206 via the plurality of fasteners in either the first orientation or the second reverse orientation.

The reversible axle shaft flange 202 may fasten to the wheel hub 206 via the plurality of fasteners in the second reverse orientation such that when the wheel, and thus the wheel hub 206, spins, so does the reversible axle shaft flange 202. However, since the reversible axle shaft flange 202 is decoupled from the axle shaft 204, the rotation is not transferred to the axle shaft 204 and consequently the electric motor may not spin as a result of the wheel spinning. Thus, the second reverse orientation of the reversible axle shaft flange 202 is suitable for a towing operation when any number of wheels are in contact with the ground.

When the reversible axle shaft flange 202 is in the second reverse orientation, the other components of the axle shaft system 200 are unchanged in position. The bearings 220, 222 remain seated within seats 224 of the bearing assembly 226. The bearing assembly is arranged between the spindle 234 and the wheel hub 206. The wheel hub 206 is affixed to the brake drum 240 via the bolt 230 affixed through the wheel hub projection 244. The wheel hub projection 244 further is affixed to the lug bolts 232.

An outboard aspect 250 of the wheel hub 206 may be configured such that when the reversible axle shaft flange 202 is in the second reverse orientation and orientated facing outboard, the splined portion 214 of the first side 210 may not affect the position, arrangement, or rotation of any of the other components of the axle shaft system 200. Thus, when in the second reverse orientation, the reversible axle shaft flange 202 may freely rotate without transferring rotation to other components.

Turning now to FIG. 3, a method of operation of an electric vehicle is shown. The method 300 may be carried out by the electric vehicle herein described, e.g., the vehicle system 106 of FIG. 1 that may comprise the axle shaft system 200 depicted in FIG. 2A. However, the method 300 may be carried out via other suitable vehicles in other examples. Method 300 may be at least partially implemented as executable instructions stored in memory in the electric vehicle of FIG. 1. Further, method 300 may include actions taken in the physical world to transform the operation mode of the electric vehicle of FIG. 1.

At 302, method 300 determines operating conditions of the electric vehicle. Vehicle operating conditions may include, but are not limited to, a drive operation mode or a towing operation mode based on orientation of a reversible axle shaft flange. The electric vehicle herein described may contain sensors to detect the orientation of the reversible axle shaft flange of an axle shaft system of the electric vehicle or to detect whether the reversible axle shaft flange is coupled to the axle shaft. Alternatively, user input, such as to a user interface (e.g., a touch screen display in a cabin of the electric vehicle), may indicate to the electric vehicle the orientation of the reversible axle shaft flange.

At 304, method 300 judges whether the electric vehicle is in a towing operation mode. The electric vehicle may be in the towing operation mode when the reversible axle shaft flange of the axle shaft system is in a second reverse orientation wherein the reversible axle shaft flange is decoupled from the axle shaft such that a wheel hub to which the reversible axle shaft flange is coupled may rotate independent of the axle shaft. The electric vehicle may be in the drive operation mode when the reversible axle shaft flange of the axle shaft system is in a first orientation wherein the reversible axle shaft flange is coupled to the axle shaft such that the axle shaft and the wheel rotate in unison.

If the electric vehicle is in the towing operation mode, then the method 300 proceeds to 308. If the electric vehicle is not in the towing operation mode, the method 300 proceeds to 306.

At 306, method 300 includes displaying to a user via a user interface an indication that the electric vehicle is not towable, such as it is in a drive operation mode (e.g., normal operation). In the drive operation mode, the axle shaft of the axle shaft system may be coupled to the wheel of the electric vehicle via the reversible axle shaft flange where the reversible axle shaft flange is in the first orientation. In the first orientation, torque and rotation may be transferred from the one or more electric machines (e.g., electric motors) of the electric vehicle to the wheels via the axle shaft and reversible axle shaft flange. Consequently, wheel spinning, as such would occur during the towing operation where the wheel is in contact with ground and the electric machine is off, may transfer rotation from the wheel to the electric machine via the reversible axle shaft flange and the axle shaft. Such rotation of the electric machine when it is not producing torque may cause degradation due to overheating or short circuits. Therefore, the electric vehicle may display an indication to the user of the electric vehicle that the electric vehicle is in drive operation mode and may not be towed. After 306, the method 300 ends. It should be understood that the method 300 may be continuously occurring and or repeated based on new operating conditions.

At 308, the method 300 includes displaying to the user via the user interface an indication that the electric vehicle is in a towing operation mode. In the towing operation mode, the reversible axle shaft flange of the axle shaft system may be decoupled from the axle shaft such that torque may not be transferred from the axle shaft to the wheel or from the wheel to the axle shaft. As such, the wheel spinning due to contact with the ground during towing may not cause the electric machine of the electric vehicle to spin. Additionally, during the towing operating mode, the one or more electric machines may not provide torque or power to the components of the electric vehicle. Consequently, the electric vehicle may display to the user that the electric vehicle is in the towing operation mode and is able to be towed and as such may not be driven as the electric vehicle is not in a drive operation mode. After 308, the method 300 ends.

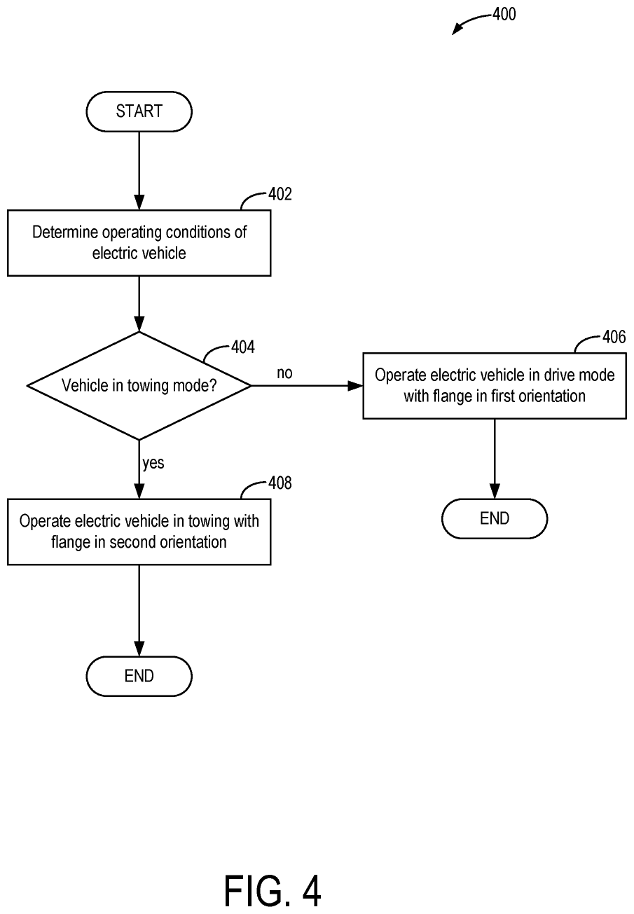

Turning now to FIG. 4, a flowchart illustrating an example method for operating mode of an electric vehicle. The method 400 may be carried out by the electric vehicle herein described, e.g., the vehicle system 106 of FIG. 1 that may comprise the axle shaft system 200 depicted in FIG. 2A. However, the method 400 may be carried out via other suitable vehicles in other examples. Method 400 may be at least partially implemented as executable instructions stored in memory in the electric vehicle of FIG. 1. Further, method 400 may include actions taken in the physical world to transform the operation mode of the electric vehicle of FIG. 1.

At 402, method 400 determines operating conditions of the electric vehicle. Vehicle operating conditions may include, but are not limited to, a drive operation mode or a towing operation mode based on orientation of a reversible axle shaft flange. The orientation of the reversible axle shaft flange may be set or changed based on user input, including manually removing and replacing the reversible axle shaft to switch the orientation.

At 404, method 400 judges whether the electric vehicle is in towing mode. If yes, method 400 proceeds to 408. Otherwise, method 400 proceeds to 406. Method 400 may judge whether the electric vehicle is in towing mode or not based on the orientation of the reversible axle shaft flange. For example, the electric vehicle may be in the drive mode when the reversible axle shaft flange is in a first orientation. In the first orientation, the reversible axle shaft flange couples to an axle shaft, allowing for transfer of rotational torque from an electric machine of the electric vehicle to a wheel coupled to the reversible axle shaft flange, as described with reference to FIG. 2A. The electric vehicle may be in the towing mode when the reversible axle shaft flange is in a second orientation (e.g., a second reverse orientation). In the second orientation, the reversible axle shaft flange is decoupled from the axle shaft and rotation of the wheel coupled to the reversible axle shaft flange is not transferred to the axle shaft or electric machine, as described with reference to FIG. 2B.

At 406, method 400 includes operating the electric vehicle in the drive mode with the reversible axle shaft flange in the first orientation. The drive mode may be a normal operation of the electric vehicle in which wheels of the vehicle derive propulsion, either forward or reverse propulsion, from rotational torque provided by one or more electric machines. After 406, the method 400 proceeds to exit.

At 408, method 400 includes operating the electric vehicle in the towing mode with the reversible axle shaft flange in the second orientation. The towing mode may include coupling the electric vehicle to a towing vehicle via a towing device. During a tow operation in which the electric vehicle is in the towing mode, at least two wheels may be in contact with a ground surface, the wheels rotating due to contact with the ground surface as the towing vehicle pulls the electric vehicle. As the reversible axle shaft flange is in the second orientation, rotational torque from the wheels may not be transferred upstream to the axle shaft or the electric machine, therefore reducing degradation to the electric machine and transmission of the electric vehicle and increasing longevity of the components.

A technical effect of the aforementioned systems and methods is that towing an electric vehicle is more efficient, as the systems and methods allow for the vehicle to be towed with wheels in contact with a ground surface without causing degradation to internal components such as an electric machine or transmission. For examples, vehicles with height or load restrictions that are not able to be flatbed towed may be towed either flat on the ground surface or with a tow dolly. Further, case of removal and replacement is increased as the reversible axle shaft flange herein described is housed within the wheel hub in both the first and second orientations, thus reducing any need for separately carrying the part during a tow operation.

The disclosure also provides support for an axle shaft system of an electric vehicle, comprising: an axle shaft, a reversible axle shaft flange optionally couplable to the axle shaft, wherein the reversible axle shaft flange is decouplable from the axle shaft, and a wheel hub coupled to the reversible axle shaft flange, wherein the wheel hub couples a wheel of the electric vehicle to the axle shaft system. In a first example of the system, the reversible axle shaft flange comprises, a first orientation wherein the reversible axle shaft flange is coupled to the axle shaft, and a second reverse orientation wherein the reversible axle shaft flange is decoupled from the axle shaft, wherein the reversible axle shaft flange is detachable from the axle shaft and the wheel hub in order to switch an orientation of the reversible axle shaft flange and reinstall in another orientation in order to decouple or couple the reversible axle shaft flange to or from the axle shaft. In a second example of the system, optionally including the first example, the axle shaft is configured to transfer torque from a differential to the wheel of the electric vehicle via the wheel hub when the reversible axle shaft flange is coupled to the axle shaft. In a third example of the system, optionally including one or both of the first and second examples, the system further comprises: a bearing assembly, wherein the bearing assembly comprises one or more bearings seated therein, the one or more bearings being configured to facilitate rotation of the axle shaft system. In a fourth example of the system, optionally including one or more or each of the first through third examples, the system further comprises: a spindle coupled to the bearing assembly and the reversible axle shaft flange when the reversible axle shaft flange is coupled to the axle shaft, the spindle being positioned between the bearing assembly and the reversible axle shaft flange. In a fifth example of the system, optionally including one or more or each of the first through fourth examples, the one or more bearings are tapered roller bearings. In a sixth example of the system, optionally including one or more or each of the first through fifth examples, the axle shaft system is a full-floating axle system. In a seventh example of the system, optionally including one or more or each of the first through sixth examples, the reversible axle shaft flange is in the first orientation during normal operation of the electric vehicle. In an eighth example of the system, optionally including one or more or each of the first through seventh examples, the reversible axle shaft flange is in the second reverse orientation during a towing operation of the electric vehicle, wherein during the towing operation, the electric vehicle is coupled to a towing vehicle via a towing device and one or more electric machines of the electric vehicle are not providing torque to components of the electric vehicle.

The disclosure also provides support for a reversible axle shaft flange of an axle shaft system of an electric vehicle, comprising: a first orientation wherein the reversible axle shaft flange is coupled to an axle shaft, and a second reverse orientation wherein the reversible axle shaft flange is decoupled from the axle shaft, wherein, in the first orientation, a first side of the reversible axle shaft flange faces inboard toward the axle shaft and, in the second reverse orientation, a second side of the reversible axle shaft flange faces inboard toward the axle shaft. In a first example of the system, the first side of the reversible axle shaft flange comprises a splined portion that protrudes axially, the splined portion of the reversible axle shaft flange coupling to a corresponding splined portion of the axle shaft when the reversible axle shaft flange is in the first orientation. In a second example of the system, optionally including the first example, the second side of the reversible axle shaft flange is substantially flat and the second side faces outboard when the reversible axle shaft flange is in the first orientation and faces inboard when the reversible axle shaft flange is in the second reverse orientation. In a third example of the system, optionally including one or both of the first and second examples: the reversible axle shaft flange is coupled to a wheel hub via a plurality of fasteners when the reversible axle shaft flange is in one of the first orientation and the second reverse orientation, and the reversible axle shaft flange is detachable from the wheel hub and the axle shaft in order to switch the reversible axle shaft flange from the first orientation to the second reverse orientation or to switch the reversible axle shaft flange from the second reverse orientation to the first orientation. In a fourth example of the system, optionally including one or more or each of the first through third examples, the reversible axle shaft flange may transfer rotation to a wheel to which it is coupled via a wheel hub from one or more electric machines via the axle shaft when the reversible axle shaft flange is coupled to the axle shaft in the first orientation, and the reversible axle shaft flange may transfer rotation from the wheel to the one or more electric machines via the axle shaft when the reversible axle shaft flange is coupled to the axle shaft in the first orientation. In a fifth example of the system, optionally including one or more or each of the first through fourth examples, the reversible axle shaft flange may not transfer rotation from the wheel to the one or more electric machines when the reversible axle shaft flange is decoupled from the axle shaft in the second reverse orientation. In a sixth example of the system, optionally including one or more or each of the first through fifth examples, the reversible axle shaft flange is in the first orientation during normal operation of the electric vehicle and is in the second reverse orientation during a towing operation of the electric vehicle.

The disclosure also provides support for a method, comprising: determining operating conditions of an electric vehicle, judging whether an axle shaft system of the electric vehicle is in a drive operation mode or a towing operation mode, the axle shaft system comprising a reversible axle shaft flange optionally coupled to an axle shaft, and displaying to a user via a user interface an operation mode that the electric vehicle is in. In a first example of the method, an orientation of the reversible axle shaft flange determines whether the electric vehicle is in the drive operation mode or the towing operation mode, wherein a first orientation includes a splined portion axially protruding from a first side of the reversible axle shaft flange coupled to a corresponding splined portion of the axle shaft, and a second reverse orientation includes a second side of the reversible axle shaft flange facing inboard toward the splined portion of the axle shaft, wherein the second side is substantially flat and the axle shaft is in a decoupled state. In a second example of the method, optionally including the first example, the method further comprises: operating the electric vehicle in the drive operation mode with the reversible axle shaft flange in the first orientation and operating the electric vehicle in the towing operation mode when the reversible axle shaft flange is in the second reverse orientation. In a third example of the method, optionally including one or both of the first and second examples: during the drive operation mode, torque is transferred from one or more electric machines to a wheel via the axle shaft that is coupled to the reversible axle shaft flange that is coupled to a wheel hub of the wheel, and during the towing operation mode, rotation is not transferred from the wheel to the one or more electric machines as the reversible axle shaft flange to which the wheel hub is coupled is decoupled from the axle shaft.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An axle shaft system of an electric vehicle, comprising:
an axle shaft;
a reversible axle shaft flange optionally couplable to the axle shaft, wherein the reversible axle shaft flange is decouplable from the axle shaft; and
a wheel hub coupled to the reversible axle shaft flange, wherein the wheel hub couples a wheel of the electric vehicle to the axle shaft system.

2. The axle shaft system of claim 1, wherein the reversible axle shaft flange comprises;
a first orientation wherein the reversible axle shaft flange is coupled to the axle shaft; and
a second reverse orientation wherein the reversible axle shaft flange is decoupled from the axle shaft, wherein the reversible axle shaft flange is detachable from the axle shaft and the wheel hub in order to switch an orientation of the reversible axle shaft flange and reinstall in another orientation in order to decouple or couple the reversible axle shaft flange to or from the axle shaft.

3. The axle shaft system of claim 1, wherein the axle shaft is configured to transfer torque from a differential to the wheel of the electric vehicle via the wheel hub when the reversible axle shaft flange is coupled to the axle shaft.

4. The axle shaft system of claim 1, further comprising a bearing assembly, wherein the bearing assembly comprises one or more bearings seated therein, the one or more bearings being configured to facilitate rotation of the axle shaft system.

5. The axle shaft system of claim 4, further comprising a spindle coupled to the bearing assembly and the reversible axle shaft flange when the reversible axle shaft flange is coupled to the axle shaft, the spindle being positioned between the bearing assembly and the reversible axle shaft flange.

6. The axle shaft system of claim 4, wherein the one or more bearings are tapered roller bearings.

7. The axle shaft system of claim 1, wherein the axle shaft system is a full-floating axle system.

8. The axle shaft system of claim 2, wherein the reversible axle shaft flange is in the first orientation during normal operation of the electric vehicle.

9. The axle shaft system of claim 2, wherein the reversible axle shaft flange is in the second reverse orientation during a towing operation of the electric vehicle, wherein during the towing operation, the electric vehicle is coupled to a towing vehicle via a towing device and one or more electric machines of the electric vehicle are not providing torque to components of the electric vehicle.

10. A reversible axle shaft flange of an axle shaft system of an electric vehicle, comprising:
a first orientation wherein the reversible axle shaft flange is coupled to an axle shaft; and
a second reverse orientation wherein the reversible axle shaft flange is decoupled from the axle shaft;
wherein, in the first orientation, a first side of the reversible axle shaft flange faces inboard toward the axle shaft and, in the second reverse orientation, a second side of the reversible axle shaft flange faces inboard toward the axle shaft.

11. The reversible axle shaft flange of claim 10, wherein the first side of the reversible axle shaft flange comprises a splined portion that protrudes axially, the splined portion of the reversible axle shaft flange coupling to a corresponding splined portion of the axle shaft when the reversible axle shaft flange is in the first orientation.

12. The reversible axle shaft flange of claim 10, wherein the second side of the reversible axle shaft flange is substantially flat and the second side faces outboard when the reversible axle shaft flange is in the first orientation and faces inboard when the reversible axle shaft flange is in the second reverse orientation.

13. The reversible axle shaft flange of claim 10, wherein:
the reversible axle shaft flange is coupled to a wheel hub via a plurality of fasteners when the reversible axle shaft flange is in one of the first orientation and the second reverse orientation; and
the reversible axle shaft flange is detachable from the wheel hub and the axle shaft in order to switch the reversible axle shaft flange from the first orientation to the second reverse orientation or to switch the reversible axle shaft flange from the second reverse orientation to the first orientation.

14. The reversible axle shaft flange of claim 10, wherein the reversible axle shaft flange may transfer rotation to a wheel to which it is coupled via a wheel hub from one or more electric machines via the axle shaft when the reversible axle shaft flange is coupled to the axle shaft in the first orientation, and the reversible axle shaft flange may transfer rotation from the wheel to the one or more electric machines via the axle shaft when the reversible axle shaft flange is coupled to the axle shaft in the first orientation.

15. The reversible axle shaft flange of claim 14, wherein the reversible axle shaft flange may not transfer rotation from the wheel to the one or more electric machines when the reversible axle shaft flange is decoupled from the axle shaft in the second reverse orientation.

16. The reversible axle shaft flange of claim 10, wherein the reversible axle shaft flange is in the first orientation during normal operation of the electric vehicle and is in the second reverse orientation during a towing operation of the electric vehicle.

17. A method, comprising:
determining operating conditions of an electric vehicle;
judging whether an axle shaft system of the electric vehicle is in a drive operation mode or a towing operation mode, the axle shaft system comprising a reversible axle shaft flange optionally coupled to an axle shaft; and
displaying to a user via a user interface an operation mode that the electric vehicle is in.

18. The method of claim 17, wherein an orientation of the reversible axle shaft flange determines whether the electric vehicle is in the drive operation mode or the towing operation mode, wherein a first orientation includes a splined portion axially protruding from a first side of the reversible axle shaft flange coupled to a corresponding splined portion of the axle shaft, and a second reverse orientation includes a second side of the reversible axle shaft flange facing inboard toward the splined portion of the axle shaft, wherein the second side is substantially flat and the axle shaft is in a decoupled state.

19. The method of claim 18, further comprising operating the electric vehicle in the drive operation mode with the reversible axle shaft flange in the first orientation and operating the electric vehicle in the towing operation mode when the reversible axle shaft flange is in the second reverse orientation.

20. The method of claim 19, wherein:
during the drive operation mode, torque is transferred from one or more electric machines to a wheel via the axle shaft that is coupled to the reversible axle shaft flange that is coupled to a wheel hub of the wheel; and
during the towing operation mode, rotation is not transferred from the wheel to the one or more electric machines as the reversible axle shaft flange to which the wheel hub is coupled is decoupled from the axle shaft.
